(19) United States
(12) Patent Application Publication
(10) Pub. No.: US 2016/0255931 A1
(43) Pub. Date: Sep. 8, 2016

(54) DEVICE FOR STORING ITEMS IN A WALLET AND OTHER CARRYING CASES

(71) Applicant: DAICHI L. NAKAGAWA, Garden Grove, CA (US)

(72) Inventor: DAICHI L. NAKAGAWA, Garden Grove, CA (US)

(21) Appl. No.: 15/157,373

(22) Filed: May 17, 2016

Related U.S. Application Data
(63) Continuation of application No. 13/871,308, filed on Apr. 26, 2013.

(51) Int. Cl. A45C 13/02; B43K 23/00

(52) U.S. Cl. CPC A45C 13/02; B43K 23/00; A45C 2013/026

(57) ABSTRACT

A device is described for carrying an item inside a wallet or other carrying cases. The device includes a base which can be inserted into a slot, a pocket or a compartment of a wallet or a carrying case. A peripheral edge of the base has a protruding part which snap fits or slip fits into and removes out of a pocket, pouch-like receptacle, compartment or cavity of a holder. An item, such as a pen, pencil, stylus, highlighter, eyeliner, nail file, flashlight, for example, can then fit inside the holder to be held inside a slot, pocket or compartment of a wallet or a carrying case. The holder of the device can be attached or fastened to the base through a variety of different attachments, including for example, rivets, loops, clips, clamps, ball joints, and hinges/slots.

### PRIORITY CLAIM

This patent application claims priority to pending U.S. patent application Ser. No. 13/871,308, titled “Device for storing items in a wallet and other carrying cases,” filed Apr. 26, 2013.

### FIELD OF THE INVENTION

The present invention relates to a device for storing items in a wallet and other carrying cases, and more particularly, to a device where an item can be inserted into the device, and where the device can be inserted and removed within a pocket, slot or compartment of a wallet or a carrying case.

### BACKGROUND OF THE INVENTION

People may have a need to carry one or more items, such as writing tools (pens, pencils and highlighters), stylus (for smart phones or tablets), cosmetic items (lipstick, eyeliner pencils, perfume, mascara, nail files, tweezers, nail clippers, small brushes, etc.), small flashlights, pen knives, letter openers, etc. These items can be carried by people in their pockets, briefcases, backpacks and handbags. Men commonly carry a wallet with them when leaving their home. Some people carry other types of carrying cases, including for example, purses, briefcases, handbags, luggage, backpacks, pocket books and computer cases.

A wallet or a carrying case may have slots, pockets and compartments for carrying paper currency, plastic cards, such as credit cards and pictures. A wallet may have different configurations including a back slot, a base slot, end slots, parallel tiered slots, pockets, folding panels and other different compartments. A collection of credit cards, identification cards, membership cards, a driver's license, and the like can be carried in these different configurations.

This otherwise efficient arrangement of card slots, pockets or compartments in wallets and carrying cases may create an unused space or gap when the wallet or carrying case is closed. This space, which has not been previously intended for any particular use or purpose, is an inherent result of most wallet and carrying case designs, and provides for the opportunity to conveniently carry additional items, such as a pen, pencil, stylus, and highlighter, for example.

Accordingly, there is a need for a device that can be structured to be inserted into and removed from a slot, a pocket, or a compartment of a typical wallet or carrying case, and which includes a way to carry small items (pen, pencil, stylus, etc) within the otherwise unused space which exists when a wallet or carrying case is folded and closed.

### BRIEF SUMMARY OF THE INVENTION

The present invention relates to a device for storing and carrying an item such as a pen, pencil, stylus, eyeliner, perfume container, nail file, flashlight, and other similar items, for example, in a wallet and other carrying cases. The device comprises a base and a holder. The base is flat and has a protruding part formed, positioned or located along a peripheral edge zone. A holder slides onto and off the protruding part of base, so as to slip fit over the base or alternatively snap fit onto and off the protruding part of base.

The base is preferably sized and configured to duplicate the dimensions of a standard credit card so that it may be inserted into and removed from a slot or compartment in a wallet or carrying case. When the base is received within the slot, the protruding part of the base remains exposed exteriorly of the slot so that it is clearly visible when the wallet or carrying case is opened. The protruding part slip fits into a pocket, receptacle, compartment or cavity in the body of the holder to securely couple or attach the base to the holder. Items can be inserted into the body or pocket of the holder to be securely held therein.

The holder when attached to the base forms a way to grasp the device in order to remove it from the slot, pocket or compartment of a wallet or carrying case. The holder, which remains exposed when an item is carried in a wallet or carrying case, provides a way to advertise, either on the holder itself, on the base, or on the item being stored therein.

With the foregoing in mind, it is an advantage of the present invention to provide a device that can store an item inside a wallet or carrying case so that the stored item occupies an otherwise empty space when the wallet or carrying case is closed.

It is another advantage of the present invention to provide a device structured to fit within a slot or pocket or compartment in a wallet or carrying case.

These and other advantages of the present invention will become more readily apparent in the description which follows.

### BRIEF DESCRIPTION OF THE DRAWINGS

FIG. 1 illustrates a top view of a device according to a preferred embodiment of the invention.

FIG. 2 illustrates a protruding part of a base and a holder of a device according to a preferred embodiment of the invention.

FIG. 3 illustrates a device according to an alternative embodiment of the invention.

FIG. 4 illustrates a side view of a protruding part of a base according to an alternative embodiment of the invention.

FIG. 5 illustrates a device according to an alternative embodiment of the invention.

FIG. 6 illustrates a device according to an alternative embodiment of the invention.

FIG. 7 illustrates a device according to an alternative embodiment of the invention.

FIG. 8 illustrates a device according to an alternative embodiment of the invention.

FIG. 9 illustrates a device according to an alternative embodiment of the invention.

FIG. 10 illustrates a device according to an alternative embodiment of the invention.

FIG. 11 illustrates a device according to an alternative embodiment of the invention.

FIG. 12 illustrates a device according to an alternative embodiment of the invention.

FIG. 13 illustrates a device according to an alternative embodiment of the invention.

### DETAILED DESCRIPTION OF THE INVENTION

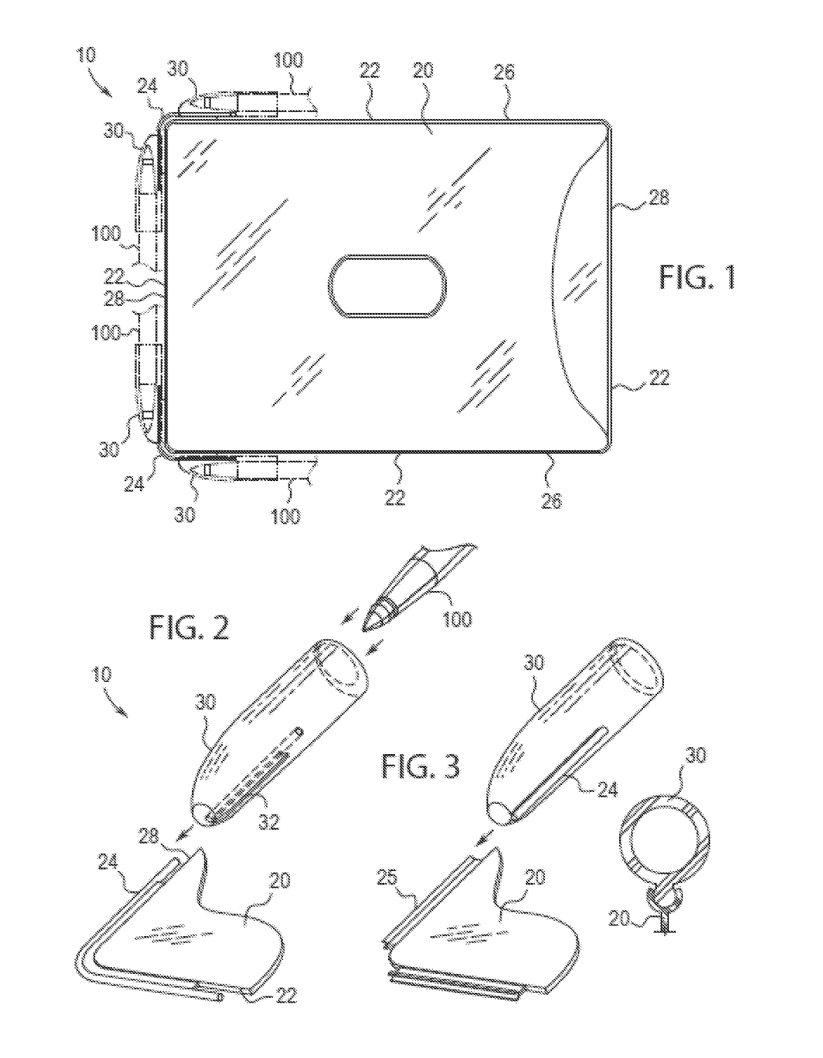

FIG. 1 illustrates a top view of a device according to a preferred embodiment of the invention. The device comprises base 20 and holder 30. Base 20 can be formed from a rigid or flexible material such as plastic or other similar materials. Base 20 may be a single piece of plastic, or two or more pieces joined together, such as shown in FIG. 1 to form a pocket for holding credit cards, money or pictures, for example. Base 20 may also include a mirror, a calendar, a calculator, a flat or foldable electronic or digital writing pad or surface (that can be uploaded to a phone, a computer, etc), a notepad with sheets of paper, or be a dispenser for a pad or a pile of sticky or other adhesive note paper, such as for example, Post-It® notes. In this embodiment, the bottom edge of the paper may be flexibly covered to allow base 20 to be inserted and withdrawn from the slot or pocket without damaging the edges or corners of the paper held thereon. Base 20 may also have a hole or an opening in the center or middle, such as shown in FIG. 1.

Base 20 is preferably sized and configured for receipt within a credit-card sized pockets, slots or compartments of a wallet or a carrying case. In alternative embodiments, base 20 can be sized to fit into any pocket, slot or compartment of a wallet or a carrying case. Although base 20 is preferably rectangular as shown in FIG. 1, base 20 may be any other shape, such as a square, triangle or semi-circular, for example. When base 20 is inserted into the pockets or slots of a wallet or carrying case, one of the peripheral edges 22 of base 20 is exposed exteriorly of the pocket or slot.

Base 20 includes a top surface, a bottom surface and a peripheral edge 22. Protruding part 24 is preferably located on peripheral edge 22 as shown in FIGS. 1 and 2, but also can be located anywhere on base 20. Protruding part 24 preferably extends along two different sides of base 20, but can also extend along all four sides of base 20 or just one side of base 20, or can also be two separate protruding parts 24 at different ends of one side of base 20. FIG. 2 shows protruding part 24 as one cylindrical piece, where one end of protruding part 24 is extending or protruding on one side (longitudinal or length-wise) of base 20, while the opposite end is extending or protruding on a perpendicular side (latitudinal or width-wise) of base 20. Protruding part 24 can be made of durable plastic or metal or any other durable composition. It can be cylindrical or any other shape, such as a square, a rectangular or semi-circular, for example. Protruding part 24 can be one piece as shown in FIG. 2, or as two or more separate pieces formed along peripheral edge 22.

Protruding part 24 is used for connecting, attaching or coupling base 20 to holder 30. A portion of protruding part 24 will snap onto, slide into, enter or go into pocket 32 of holder 30. Pocket 32 of holder 30 can also be a pouch-like receptacle, compartment or cavity in the body of holder 30. There is an opening or hole of pocket 32 on the exterior body of holder 30. By having a separation or gap between protruding part 24 and base 20, protruding part 24 will snap onto, or slide into pocket 32 of holder 30, and make contact inside of pocket 32 of holder 30. Holder 30 will be attached, connected or coupled to base 20 via protruding part 24 with sufficient force to be securely held therein. Holder 30 can be removed from base 20 by snapping off, sliding or pulling base 20 or holder 30 in the opposite directions from how holder 30 was inserted into base 20, thereby freeing base 20 from holder 30.

Protruding part 24 may have one cylindrical diameter, such as shown in FIG. 1. However in alternative embodiments, protruding part 24 may gradually increase or decrease in diameter toward the end, whereby a larger or smaller part of protruding part 24 would be inserted into pocket 32 of holder 30. Instead of protruding part 24 being parallel with peripheral edge 22 of base 20, protruding part 24 may extend at an angle to give protruding part 30 extra force to securely hold holder 30 onto base 20. In addition, pocket 32 of holder 30 could be formed or molded at an angle, so that protruding part 30 slip fits inside pocket 32 at a predetermined angle. Additionally, instead of protruding part 24 being preferably made of a stiff plastic, protruding part 24 may be flexible plastic, metal or other material. For example, protruding part 24 would be similar to a clip found on pens and mechanical pencils, where this clip is used to hold a pen or mechanical pencil onto a shirt pocket with a certain amount of force, for example.

FIG. 3 illustrates a device according to an alternative embodiment of the invention. Although it is preferred that protruding part 24 is part of base 20, in an alternative embodiment, protruding part 24 could be located on holder 30 as shown in FIG. 3. In this configuration, base 20 would comprise a receptacle, retainer or tube 25, where protruding part 24 of holder 30 would snap onto, slide into, enter or go into the receptacle, retainer or tube 25 of base 20. In another alternative embodiment, base 20 may have multiple receptacles, retainers or tubes 25 located on multiple locations on the peripheral edge 22, to permit holder 30 to be attached at different places on base 20.

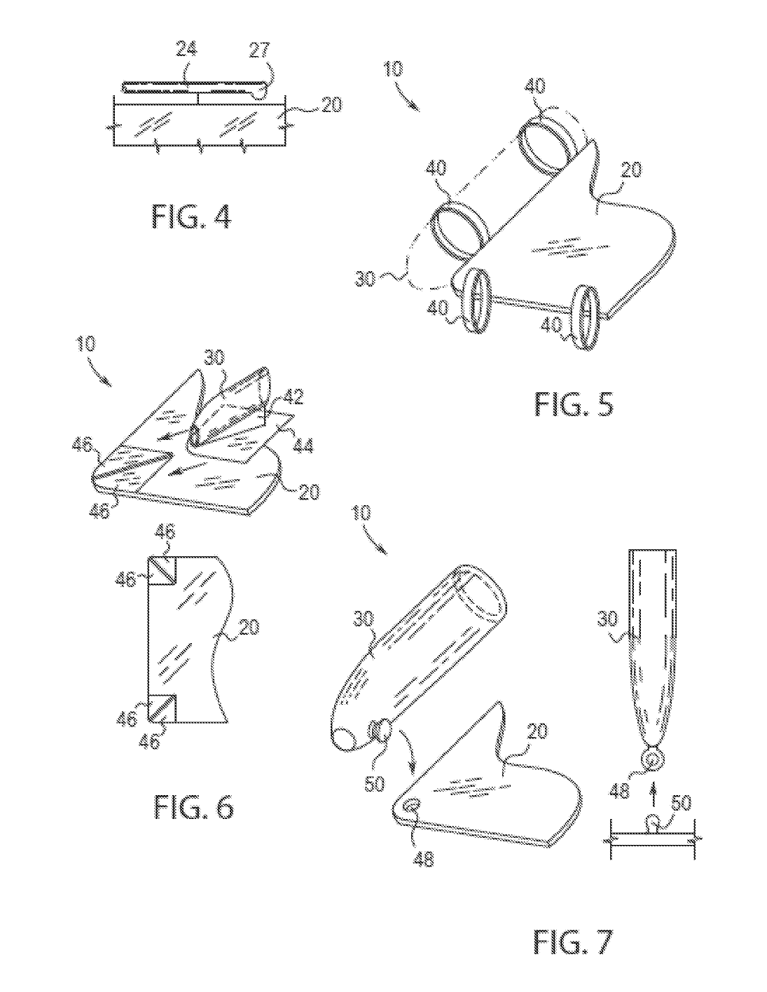

FIG. 4 illustrates a side view of a protruding part of a base according to an alternative embodiment of the invention. FIG. 4 shows that protruding part 24 may also have a protrusion 26 (lip, flange, overhang, extension or similar design) at one end for grasping or holding onto the inside of holder 30. Where the protrusion 26 joins or makes contact inside pocket 32 of holder 30, this area inside holder 30 may also have a protrusion, whereby extra force is required first to insert protrusion 26 over a protrusion inside pocket 32 of holder 30, and to remove or pull protrusion 26 over the protrusion inside pocket 32 of holder 30. Using this configuration, base 20 would interlock onto holder 30. There may be other ways of interlocking base 20 to holder 30 which are known to those skilled in the art, all of which are included herein.

It is preferable that base 20 and holder 30 are separate components that can be joined together and separated from each other. However, in alternative embodiments, protruding part 24 of base 20 could be permanently attached to holder 30 by any means, including being molded as a single piece, whereby base 20, protruding part 24 and holder 30 would be molded as one piece of plastic. In another alternative embodiment, base 20 and holder 30 could be fastened or affixed to one another by glue or other adhesives, or affixed to each other by hook and loop, such as Velcro, for example. All other ways or attaching or fastening base 20 to holder 30 which are known to those skilled in the art are included herein.

It is preferable that pocket 32 of holder 30 should be located, positioned or contained within the body of holder 30. However, in an alternative embodiment, pocket 32 could be located on the exterior surface of holder 30. In another alternative embodiment, pocket 32 of holder 30 could be replaced with an opening or hole in the body of holder 30. In this alternative embodiment, protruding part 24 would be inserted in the opening or hole. An item could be inserted into holder 30, whereby the item creates pressure on protruding part 24 to hold holder 30 onto base 20.

Holder 30, as shown in FIGS. 1 and 2, is structured to releasably capture item 100, such as a pen, pencil, cosmetic instrument, flashlight, or other similar instruments or items, in a stowed position for subsequent retrieval as needed. In the preferred embodiment, there is an opening on one end of the holder 30 where item 100 can be inserted and removed. Holder 30 is preferably made from durable plastic, although holder 30 can be made from any other material such as wood, silver or gold for example. Holder 30 is preferably separate from item 100, although in alternative embodiments, holder 30 may be affixed, immovably attached or molded into the end of item 100, thereby making holder 30 and item 100 structurally one piece.

It is preferred that holder 30 has a closed end with an opening or pocket on the other end, such as shown in FIGS. 1 and 2. In the preferred embodiment, item 100 can be inserted therein and the tip of the pen, pencil or stylus, for example, would not stick out or protrude from holder 30. In alternative embodiments, holder 30 may have two ends which are open. Having two openings would permit item 100 to be inserted therein, where the tip of the pen, pencil or stylus for example, would protrude from holder 30. In this embodiment, protruding part 24 may be centered on base 20, where holder 30 would attach or connect to base 20 in the center region instead of at the corners of base 20 as shown in FIG. 1.

The inside of holder 30 is preferably smooth. However, in alternative embodiments, the inside of holder 30 could be lined any type of material, such as rubber, malleable gel, or hook and loop, such as Velcro for example, to give more friction and more permanence, durability or immovability in securely holding item 100 inside holder 30. In another alternative embodiment, a ribbon or similar material could be used for holding an item inside holder 30 or holder 30 itself, where the ribbon would wrap around item 100. One end of the ribbon could be pulled and attached to a slot in base 20.

FIGS. 5 through 13 show alternative embodiments of device 10, where holder 30 is permanently or removably attached to base 20 via a variety of different attachments, connections or fasteners. FIG. 5 illustrates device 10 according to an alternative embodiment of the invention. Device 10 comprises base 20 having loops 40 and holder 30. Groups of two or more loops 40 are formed on or close to the peripheral edge of base 20. As illustrated in FIG. 5, there are two loops 40 formed on one side of base 20 and two loops 40 formed on another side of base 20. Holder 30 would be inserted into the loops 40 such as shown in FIG. 5. The outside of holder 30 may have a protruding part, such as shown in FIG. 4 for example, that would slide over one or both of loops 40 to additionally fasten holder 30 onto loops 40. In yet another variation, the item itself would be inserted into and removed from loops 40 without the need for holder 30.

FIG. 6 illustrates an alternative embodiment of device 10. Device 10 comprises holder 30 and base 20. Holder is attached via hinge 42 to insert base 44. Hinge 42 on insert base 44 slides into a slot, gap or space formed by the positioning of flaps 46 on base 20. The slot, gap or space formed is preferably at 45 degrees from the peripheral edge of base 20, although other angles could be used as well. Hinge 42 gives holder 30 the ability to be positioned or aligned on base 20 in at least two different positions. Holder 30 can be oriented by moving hinge 42 in one direction (along the smaller side of base 20) or in the other direction (along the longer side of base 20). Holder 30 as shown in FIG. 6 allows device 10 to be stored length-wise or width-wise in a slot or pocket of a wallet or a carrying case. In an alternative embodiment, hinge 42 would permanently attach to base 20. In this alternative embodiment, holder 30 is permanently or removably attached to hinge 42.

FIG. 7 illustrates an alternative embodiment of device 10. Device 10 comprises base 20 and holder 30. Holder 30 has a hole or opening 48 at one end. This opening 48 can be formed by a collar 48 attached to one end of holder 30 as shown on the left-side of FIG. 7. Base 20 has nub 50 that extends in a perpendicular direction from the plane of base 20. The opening in collar 48 of holder 30 can be pushed onto nub 50 of base 20 to attach holder 30 to base 20. To detach holder 30 from base 20, pressure is exerted to remove nub 50 of base 20 from collar 48 of holder 30. It can be appreciated that the collar/nub combination can be made permanent, where holder 30 would permanently attached to base 20 via collar 48 and nub 50.

In an alternative embodiment shown on the right-side of FIG. 7, the collar/nub combination is reversed, so that nub 50 is part of holder 30 and collar 48 is part of base 20. However, the insertion and the removal remain the same. An alternative design would be the use of a commercially available circular fastener, such as an Eyelet kit.

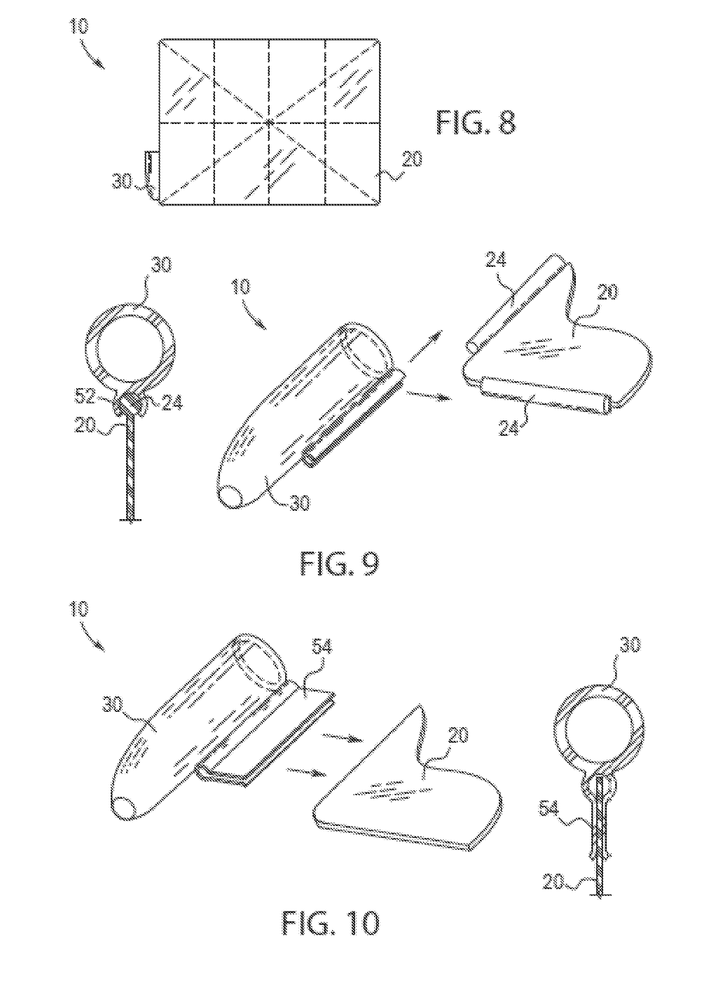

FIG. 8 illustrates an alternative embodiment of device 10. Device 10 comprises base 20 and holder 30, where holder 30 is permanently fixed or attached along one edge of base 20. Holder 30 could also be fixed along the longer side of base 20. In FIG. 8, base 20 is not rigid but flexible, and can be folded along the lines into a smaller size than the size of a normal credit card. The fold lines shown in FIG. 7 are for illustration purposes only, because the card could be folded in any configuration as one would desire.

FIG. 9 illustrates an alternative embodiment of device 10. Device 10 comprises base 20 having protruding part 24, and holder 30. Instead of holder 30 having pocket 32 which is illustrated in FIG. 2, holder 30 as shown in FIG. 9 has receptacle 52 at the larger end of the holder 30 (i.e. the end where items are inserted into and removed from holder 30). Protruding part 24 is made to snap on or slide into receptacle 52. Receptacle 52 can be formed so that protruding part 24 locks into receptacle 52. In another alternative embodiment, receptacle 52 could be located on the opposite end of holder 30.

FIG. 10 illustrates an alternative embodiment of device 10. Device 10 comprises base 20 and holder 30 having clip 54. Clip 54 is commercially available and is permanently or removably attached to holder 30. Clip 54 can be released and clasped or clipped to any side of base 20. This alternative embodiment could also be reversed, whereas the base 30 would have clip 54 permanently attached along the edge and would clasp or clip to holder 30.

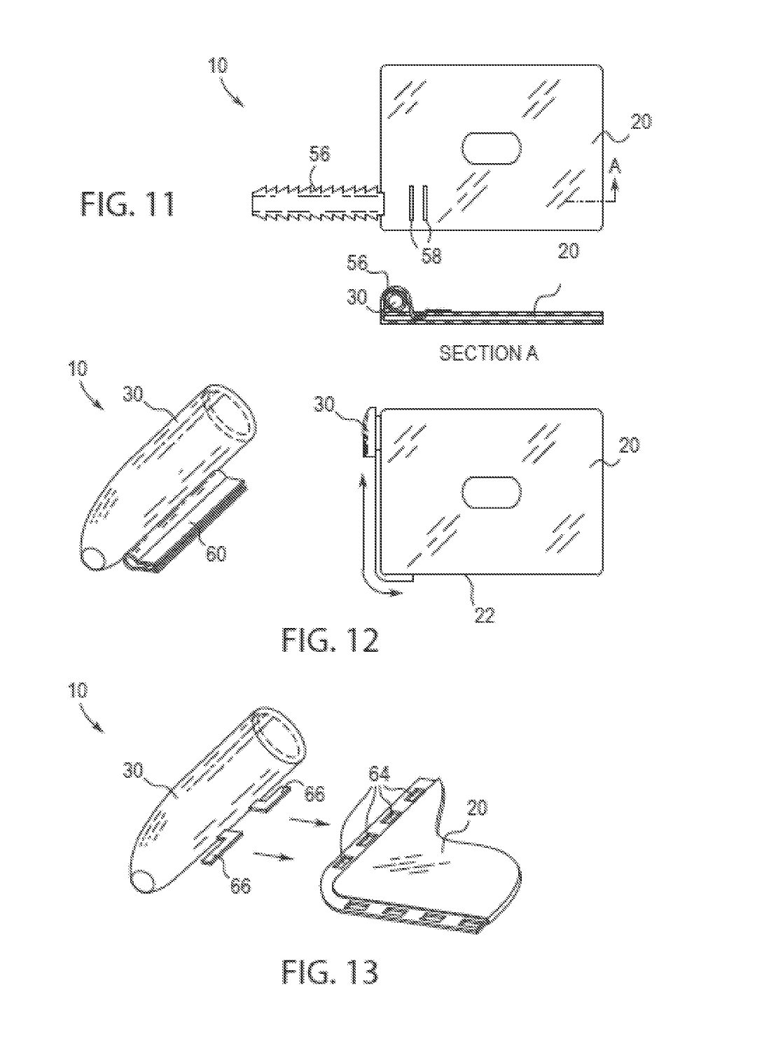

FIG. 11 illustrates an alternative embodiment of device 10. Device 10 comprises base 20 and holder 30. On base 20, one end of strap, belt or ribbon 56 is permanently attached to base 20. The other end of strap 56 goes over and around an item inside holder 30 or holder 30 itself, as shown in FIG. 11, slides into and out slots 58 of base 20. Strap 56 can alternatively have grip teeth so that strap 56 is securely held by slots 58.

FIG. 12 illustrates an alternative embodiment of device 10. Holder 30 comprises slider 60 permanently attached to one side of the exterior surface of holder 30. Slider 60 then can be attached to base 20, and is moveable by sliding along a receiving track on peripheral edge 22 of base 20. Slider 60 is commercially available and is similar to the piece located on a Ziploc bag for opening/closing the bag. This alternative embodiment could also be reversed, whereas the base 20 comprises slider 60 on the entire peripheral edge 22 and would permanently attach to the receiving track on holder 30.

FIG. 13 illustrates an alternative embodiment of device 10. Base 20 comprises perforations 64 or cut-outs on peripheral edge 22 to accept hook notches 66 on holder 30 for secure attachment. Perforations 64 are evenly spaced on one or more sides of base 20. This alternative embodiment could also be reversed, whereas the base 20 would have hook notches 66 to securely attach to perforations or cut-outs 64 on holder 30.

In an alternative embodiment, base 20 comprises a commercially available digital writing pad or tablet. Some digital writing surfaces or tablets are foldable as shown in FIG. 8. The digital tablet would include at a minimum, a microprocessor and a battery. Digital memory or storage may be part of the microprocessor or may be another memory device connected to the microprocessor. There also may be a button or sensor for turning the writing surface on and off, whereby the activation or deactivation of the digital writing pad or tablet would allow automatic data synchronization onto a separate external device wirelessly or via cables. Using a stylus or similar device, a person can write or draw on the digital surface. The writing and drawing would be stored in memory in the tablet, and could be uploadable at a later time, versus automatic synchronization, to a smart phone, computer or similar electronic device via Bluetooth, a wireless connection or cables.

As illustrated herein, holder 30 of device 10 can be joined or attached to base 20 via a variety of different attachments, such as collars, loops, clamps, clips, and hinges/slots. It is also envisioned that there are similar ways that holder 30 could be attached 20 which were not specifically shown herein, but which are apparent to those skilled in the art and included herein. Also, it is apparent to those skilled in the art that one or more illustrated attachments could be combined or reversed, and thus, are included herein. For example, holder 30 and base 20 each could have a protruding part and a receptacle, giving the option of connecting holder 30 to base 20 via two different ways. In another example, a hook and loop, such as a Velcro attachment or shaped connections, such as Lego attachment, could be used to attach, connect or couple holder 30 to base 20.

The present invention can be utilized with a wide variety of wallets, pursues or any other accessory which provides a space for a credit card. While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A device comprising:
a base having a size less than or substantially equal to a business card, the base being configured to be inserted into one of a slot, a pocket and a compartment; and
a holder having a receptacle configured for receipt of one of a stylus, a pen and a pencil, said holder having an attachment, the attachment being configured for connecting the holder to the base, wherein the base further comprises a collar where the attachment connects to the collar and the holder.

2. A device comprising:
a base having a size less than or substantially equal to a business card, the base being configured to be inserted into one of a slot, a pocket and a compartment; and
a holder having a receptacle configured for receipt of one of a stylus, a pen and a pencil, said holder having an attachment, wherein the attachment is hinged to the base and the holder, thereby permitting the holder to align along two different sides of the base.

3. A device comprising:
a base having a size less than or substantially equal to a business card, the base being configured to be inserted into one of a slot, a pocket and a compartment; and
a holder having a receptacle configured for receipt of one of a stylus, a pen and a pencil, said holder having an attachment wherein the base has at least one slot, and wherein the attachment comprises:
a hinge, and a second base attached to the hinge, wherein the hinge is configured to be inserted into the at least one slot in the base and the hinge is configured to be slid underneath the at least one slot in the base.

4. The device of claim 3, wherein the slot of the first base is formed at an angle of forty-five degrees to a corner of the base.
